(19) United States
(12) Patent Application Publication
(10) Pub. No.: US 2026/0147849 A1
(43) Pub. Date: May 28, 2026

(54) CONTENT GENERATION AND PRESENTATION USING ON-DEVICE SUBSCRIPTION DATA

(71) Applicant: Adobe Inc., San Jose, CA (US)

(72) Inventors: Viswanathan SWAMINATHAN, Saratoga, CA (US); Saayan Mitra, San Jose, CA (US); Gavin Stuart Peter Miller, Los Altos, CA (US); Eunyee Koh, Sunnyvale, CA (US); Deepak Pai, Sunnyvale, CA (US)

(21) Appl. No.: 18/957,520

(22) Filed: Nov. 22, 2024

(51) Int. Cl. G06F 16/957

(52) U.S. Cl. CPC G06F 16/9577

(57) ABSTRACT

Some aspects relate to technologies for generating and/or presenting digital content using on-device subscription data maintained on a user device. In some aspects, a user device receives a content intent descriptor communicated over a network from a content server. The user device performs a comparison of on-device subscription data with the content intent descriptor. Based on the comparison, the user device generates a prompt using the content intent descriptor. A generative model is caused to generate a digital content item using the prompt, and the digital content item is presented on the user device.

### BACKGROUND

Personalization of digital content on the Internet involves tailoring digital experiences to individual users based on things like their preferences, behaviors, and interactions. This process often leverages contextual data regarding a user such as user demographics, browsing history, search queries, and social media activity to deliver relevant digital content including advertisements, recommendations, and other information. Personalization enhances user engagement by making digital content delivered to user devices more relevant. However, it can also raise concerns about privacy and data security, as it often relies on collecting and analyzing personal information.

### SUMMARY

Some aspects of the present technology relate to, among other things, generating and/or presenting digital content from a content server based on on-device subscription data maintained on a user device. In some configurations, digital content is generated on the user device. In accordance with such configurations, the user device receives a content intent descriptor from the content server. The user device performs a comparison of the content intent descriptor to on-device subscription data to determine if the user device is subscribed to generate and present a digital content item based on the content intent descriptor. When subscribed based on the comparison, the user device generates a prompt using the content intent descriptor. The prompt is then fed into a generative model, which creates a digital content item tailored based on the content intent descriptor. The generated digital content item is presented on the user device.

Other configurations involve the presentation of server-provided digital content on a user device based on on-device subscription data maintained on a user device. In accordance with such configurations, the user device receives a digital content item from the content server. The user device performs a comparison of the digital content item to on-device subscription data to determine if the user device is subscribed to present the digital content item. When subscribed based on the comparison, the user device presents the digital content item.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a sequence diagram illustrating a sequence of actions performed by a content server and a user device to generate digital content on the user device using on-device subscription data and a content intent descriptor in accordance with some implementations of the present disclosure;

FIG. 3 is a flow diagram showing a method performed by a user device to generate a digital content item on the user device using on-device subscription data and a content intent descriptor in accordance with some implementations of the present disclosure;

FIG. 4 is a block diagram illustrating another exemplary system in accordance with some implementations of the present disclosure;

FIG. 5 is a sequence diagram illustrating a sequence of actions performed by a content server and a user device to present server-provided content on the content server using on-device subscription data in accordance with some implementations of the present disclosure;

FIG. 6 is a flow diagram showing a method performed by a user device for server-provided content presentation using on-device subscription data and a content intent descriptor in accordance with some implementations of the present disclosure; and

FIG. 7 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, the term “digital content item” refers to digital media that can be presented by user devices and, in some cases, communicated over a network, such as the Internet. A digital content item can include one or more modalities, such as text, image, audio, and video. A digital content item can be any of a variety of different types. By way of example, in some aspects, a digital content item comprises marketing content (also referred to as a marketing message), intended to promote a product or service or to otherwise cause a potential customer to perform some action. In other aspects, a digital content item comprises other types of content, such as recommendations, news, push notifications, or other information.

The term “on-device subscription data” is used herein to refer to information that is maintained on an end user's user device (e.g., a mobile device, tablet, or laptop computer) and that specifies the types of digital content the end user prefers to consume (or prefers not to consume). On-device subscription data can include information explicitly provided by an end user and/or information identified or otherwise determined by the end user's user device, for instance, based on user actions on the user device. In accordance with aspects of the technology described herein, on-device subscription data on a user device is used by the user device to determine what digital content to present, essentially acting as a personalized content filter.

The term “content intent descriptor” is used herein to refer to a data object that encapsulates information about the intended purpose and objectives of digital content to be generated and presented on a user device. A content intent descriptor can comprise data in different formats, such as text, images, audio, and/or video. By way of example only and not limitation, in the context of generating a marketing message, a content intent descriptor can comprise information regarding one or more products/services to be advertised. For instance, a content intent descriptor could include information based on a creative brief or a campaign brief that provides details for the creation of marketing content, which could include information regarding an objective, target audience, key message, tone, style, and type of digital content item to generate. In other instances, a content intent descriptor can specify information used to generate other forms of digital content items, such as recommendations, news, push notifications, or other information. Content intent descriptors can be defined by different entities, allowing each entity to have one or more descriptors tailored to their specific needs. For example, different advertisers can create unique content intent descriptors for their products, ensuring that the generated content aligns with their distinct marketing strategies and objectives.

As used herein, the term “prompt” refers to input to a generative model that guides or otherwise instructs the generative model to generate a digital content item. In accordance with aspects of the technology described herein, a prompt is generated based on a content intent descriptor and, in some cases, also using on-device contextual data. A prompt can comprise any combination of text, images, audio, video, or other input format.

The term “on-device contextual data” is used herein to refer to information or metadata about an end user, such as an end user's characteristics, environment, behaviors, or circumstances that is maintained on the end user's user device, such as a mobile device, tablet, or laptop computer. On-device contextual data can include, for instance: user demographics (e.g., age, gender, etc.); user geolocation (e.g., through IP address or GPS data); user device information (e.g., device type, operating system, browser, etc.); user behavior data regarding actions such as page views, clicks, time spent on a website, or previous engagement with specific digital content items. On-device contextual data can include information explicitly provided by an end user and/or information identified or otherwise determined by the end user's user device, for instance, based on user actions on the user device. In some aspects, the on-device contextual data can include any information on the user device, such as information from calendar entries, emails, and text messages.

A “generative model” is a type of machine learning model that learns to generate output digital content from a given training dataset. Unlike discriminative models, which focus on predicting a label or class for input data, generative models aim to understand the underlying distribution of the data in order to generate output digital content. Generative models can generate output digital content by sampling from this learned distribution, in order to perform tasks like image generation and text synthesis. Examples of generative models include Variational Autoencoders (VAEs) and Generative Adversarial Networks (GANs). In some aspects, a generative model can comprise a large language model (LLM). In some aspects, the generative model can be a multi-modal model that operates on inputs and/or generate outputs of different modalities, such as text, image, audio, and video.

### Overview

Given the vast number of user devices and the incredible amount of digital content distributed on the Internet, the generation and delivery of digital content items to user devices that is personalized for the recipients poses a technical challenge for content servers. For instance, in the current digital marketing era, enterprises face the challenge of creating digital content items in various form, such as display ads. The need for a plethora of new, unique, and appealing digital content items that are personalized to recipients presents a significant challenge.

One form of personalization for digital content involves selecting what digital content to provide to end users based on their preferences. For instance, some current services require end users to explicitly provide their preferences or to allow the services to track their activities such that the services can provide digital content relevant to each end user. However, this often requires access to the users'personal data and preferences, potentially presenting privacy concerns. While some users may be comfortable sharing such personal data, others are not. When the personal data available for a given user is limited, the user experience suffers.

Aspects of the technology described herein address these technical challenges by employing on-device subscription data to determine whether to generate and/or to present digital content items on an end user's user device. The on-device subscription data generally includes information that specifies the types of digital content the end user prefers to consume (or prefers not to consume). The on-device subscription data is maintained on the user device of the end user, thereby addressing any privacy concerns. By maintaining the subscription data on the user device, the type of digital content the user views is kept private.

Some configurations described herein involve using on-device subscription data on a user device to determine whether to generate digital content items directly on the user device. In such configurations, a content server stores content intent descriptors, each of which is a data object encapsulating information about the intended purpose and objectives of digital content to be generated. When the user device receives a content intent descriptor from the content server, the user device compares the content intent descriptor (and/or associated metadata) to the on-device subscription data to determine whether to generate and present a digital content item using the content intent descriptor. If the user device is subscribed to content based on the content intent descriptor and the on-device subscription data, the user device generates a prompt using the content intent descriptor. The prompt is provided to a generative model on the user device to generate a digital content item, which is then presented on the user device. In some aspects, the user device also stores on-device contextual data, which generally includes information about an end user's characteristics, environment, behaviors, or circumstances that is maintained on the user device. In such configurations, the user device can generate the prompt using both the received content intent descriptor and the on-device contextual data. By combining on-device contextual data with content intent descriptors on a user device, personalized digital content can be generated in a way that secures the end user's contextual data.

Other configurations described herein involve a user device receiving a digital content item from a content server and determining whether to present the digital content item on the user device based on on-device subscription data. In such configurations, when the user device receives a digital content item from the content server, the user device compares the digital content item (and/or associated metadata) with the on-device subscription data. If the user device determines it is subscribed to present the digital content item based on the comparison to the on-device subscription data, the user device presents the digital content item. Otherwise, the digital content item is not presented and can be deleted from the user device.

Aspects of the technology described herein provide a number of improvements over existing technologies. For instance, the technology described herein leverages on-device subscription data to control what digital content is presented on the user device. In this way, what is presented to the end user of the user device can be controlled by the user device without exposing what content is presented and what content is not presented on the user device. Although a content server provides content intent descriptors or digital content items to a user device, whether the user device presents digital content based on what is received from the content server is not exposed since the on-device subscription data is maintained on the user device. Moreover, configurations in which digital content items are generated on the user device using on-device contextual data enable the creation and presentation of personalized digital content items without transmitting personal data over a network or otherwise storing personal data on a server. Instead, personal data for an end user is maintained as on-device contextual data on the end user's user device. As such, this approach leverages on-device data to enhance personalization while maintaining user privacy, as the contextual data remains on the user device (e.g., the contextual data never leaves the user device).

### User Device Content Generation Using On-Device Subscription Data

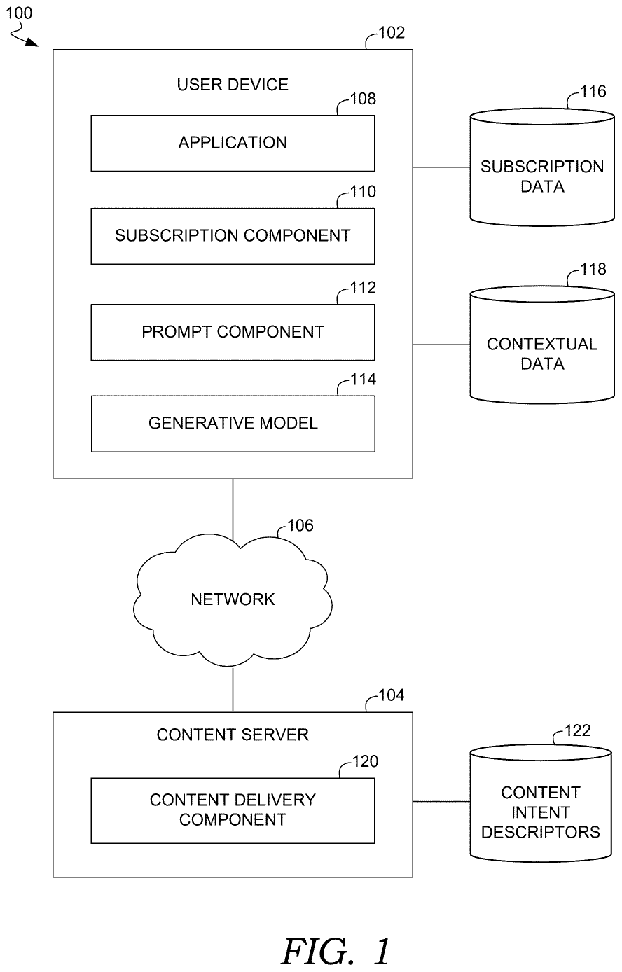

With reference now to the drawings, FIG. 1 is a block diagram illustrating an exemplary system 100 for generating digital content items on a user device using a content intent descriptor and on-device subscription data in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

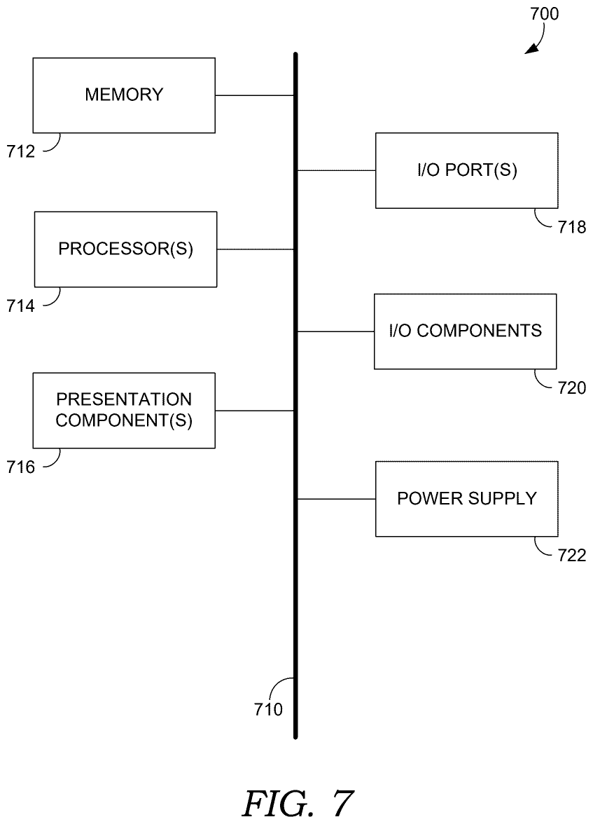

The system 100 is an example of a suitable architecture for implementing certain aspects of the present disclosure. Among other components not shown, the system 100 includes a user device 102 and a content server 104. Each of the user device 102 and the content server 104 shown in FIG. 1 can comprise one or more computer devices, such as the computing device 700 of FIG. 7, discussed below. As shown in FIG. 1, the user device 102 and the content server 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the content server 104 could be provided by multiple server devices collectively providing the functionality of the content server 104 as described herein. Additionally, other components not shown may also be included within the network environment.

The user device 102 can be a client device on the client-side of operating environment 100, while the content server 104 can be on the server-side of operating environment 100. The content server 104 can comprise server-side software designed to work in conjunction with client-side software on the user device 102 so as to implement any combination of the features and functionalities discussed in the present disclosure. For instance, the user device 102 can include an application 108 for interacting with the content server 104 and presenting digital content items on the user device 102. The application 108 can be, for instance, a web browser or a dedicated application for providing functions, such as those described herein. This division of operating environment 100 is provided to illustrate one example of a suitable environment, and there is no requirement for each implementation that any combination of the user device 102 and the content server 104 remain as separate entities. While the operating environment 100 illustrates a configuration in a networked environment with a separate user device and content server, it should be understood that other configurations can be employed in which aspects of the various components are combined. For instance, in some aspects, aspects of the content server 104 can be implemented at least in part by the user device 102 and vice versa.

The user device 102 can comprise any type of computing device capable of use by a user. For example, in one aspect, the user device 102 can be the type of computing device 700 described in relation to FIG. 7 herein. By way of example and not limitation, the user device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. An end user can be associated with the user device 102.

The content server 104 can be implemented using one or more server devices, one or more platforms with corresponding application programming interfaces, cloud infrastructure, and the like. While the content server 104 is shown separate from the user device 102 in the configuration of FIG. 1, it should be understood that in other configurations, at least some of the functions of the content server 104 can be provided on the user device 102 and vice versa.

As shown in FIG. 1, the user device 102 includes a subscription component 110, a prompt component 112, and a generative model 114; and the content server 104 includes a content delivery component 120. The components of the system 100 may be in addition to other components that provide further additional functions beyond the features described herein. In some aspects, the functions performed by components of the system 100 are associated with one or more applications, services, or routines. In particular, such applications, services, or routines may operate on one or more user devices, servers, may be distributed across one or more user devices and servers, or be implemented in the cloud. Moreover, in some aspects, these components of the system 100 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The content server 104 is a computer system designed to store, manage, and deliver digital content over the network 106 to user devices, such as the user device 102. Among other things, the content server 104 maintains a repository of one or more content intent descriptors, shown in FIG. 1 as the content intent descriptors data store 122. Each content intent descriptor is a data object that encapsulates information about the intended purpose and objectives of digital content to be generated and presented on a user device. A content intent descriptor can comprise data in different formats, such as text, images, audio, and/or video. By way of example only and not limitation, in the context of generating a marketing message, a content intent descriptor can comprise information regarding one or more products/services to be advertised. For instance, a content intent descriptor could include information based on a creative brief or a campaign brief that provides details for the creation of marketing content, which could include information regarding an objective, target audience, key message, tone, style, and type of digital content item to generate. In other instances, a content intent descriptor can specify information used to generate other forms of digital content items, such as recommendations, news, push notifications, or other information. Content intent descriptors can be defined by different entities, allowing each entity to have one or more descriptors tailored to their specific needs. For example, different advertisers can create unique content intent descriptors for their products, ensuring that the generated content aligns with their distinct marketing strategies and objectives.

The content server 104 includes a content delivery component 120, which transmits content intent descriptors over the network 106 to user devices, such as the user device 102. The content delivery component 120 can provide content intent descriptors to user devices in a variety of different scenarios in which digital content is to be presented by the user devices. These include situations in which user devices request content from the content server 104 and situations in which the content server 104 pushes content to user devices. By way of example and not limitation, this could include scenarios involving the presentation of advertisements and other marketing messages, recommendations, news feeds, push notifications, and other content on the user devices.

The user device 102 stores on-device subscription data in a subscription data store 116 maintained on the user device 102. The on-device subscription data comprises information that specifies the types of digital content the end user prefers to consume (or prefers not to consume). The on-device subscription data can include information explicitly provided by the end user and/or information identified or otherwise determined by the user device 102, for instance, based on user actions on the user device.

In some aspects, the on-device subscription data is securely maintained on the user device 102 using one or more data security strategies. For instance, the on-device subscription data can be encrypted, ensuring that data is converted into a secure format that can only be accessed by authorized entities. This can be achieved, for instance, through full-disk encryption or file-level encryption. Access control mechanisms can also be employed that limit access to the on-device subscription data to specific applications via authentication. For instance, access to the on-device contextual data could be authorized for just the subscription component 110 such that other applications and components on the user device cannot access the data.

The on-device subscription data is used by the user device 102 to determine what digital content to present, essentially acting as a personalized content filter. In the configuration of FIG. 1, when the user device 102 receives a content intent descriptor from the content server 104, the subscription component 110 on the user device 102 uses the on-device subscription data to determine whether to generate and present a digital content item on the user device 102 using the content intent descriptor. The subscription component 110 compares the content intent descriptor (or metadata associated therewith) to the on-device subscription data to determine whether to generate and present a digital content item. This can be done in a number of different ways. For instance, in some aspects, the subscription component 110 uses one or more of the following:
keyword matching that determines if keywords from the content intent descriptor (or from metadata associated therewith) match (or are similar to) keywords from the on-device subscription data; category matching that compares a category of the content intent descriptor to preferred (and/or undesired) categories in the on-device subscription data; preference scoring that assigns a score to the content intent descriptor as a function of how well the content intent descriptor matches the end user's subscription preferences set forth by the on-device subscription data; and using machine learning approaches to determine whether to generate content from the content intent descriptor based on complex patterns in the on-device subscription data and/or the content intent descriptor.

When the subscription component 110 determines the user device 102 is subscribed for the received content intent descriptor, the user device 102 uses the content intent descriptor to generate a digital content item that is presented by the application 108 on the user device. More particularly, the user device 102 includes a prompt component 112 that provides a prompt for input to a generative model 114 to generate a digital content item. The prompt can be any input that guides the generative model 114 in creating a digital content item and can include various input formats such as text, images, audio, video, or a combination thereof.

The prompt component 112 generates the prompt using the content intent descriptor received from the content server 104. In some instances, the prompt component 112 simply provides the content intent descriptor as input to the generative model (i.e., the prompt is the content intent descriptor). In some aspects, the prompt component 112 provides a prompt (which could be pre-defined text) that instructs the generative model 114 to generate a digital content item using the content intent descriptor. In some aspects, the prompt component 112 uses on-device subscription data to select relevant information from the content intent descriptor for use in generating the prompt. For example, if the content intent descriptor includes information for multiple items (e.g., news categories), the prompt component 112 could generate a prompt using information for one of those items that aligns best with the end user's preferences as set forth by the on-device subscription data.

In some aspects, the prompt component 112 uses on-device contextual data in conjunction with the content intent descriptor when generating a prompt. By leveraging both the content intent descriptor and on-device contextual data, the prompt component 112 can generate highly personalized and relevant prompts that guide the generative model 114 to create digital content items tailored to the end user's preferences and context. In such configurations, the user device 102 stores on-device contextual data in a contextual data store 118 maintained on the user device 102. The on-device contextual data includes information or metadata about an end user of the user device 102, such as the end user's characteristics, environment, behaviors, or circumstances. The on-device contextual data can include, for instance: user demographics (e.g., age, gender, etc.); user geolocation (e.g., through IP address or GPS data); user device information (e.g., device type, operating system, browser, etc.); user behavior data regarding actions such as page views, clicks, time spent on a website, or previous engagement with specific digital content items. The on-device contextual data can include information explicitly provided by the end user of the user device 102 and/or information identified or otherwise determined by the user device 102, for instance, based on user actions on the user device 102. In some aspects, the on-device contextual data can include any information on the user device, such as information from calendar entries, emails, and text messages.

In some aspects, the on-device contextual data is securely maintained on the user device 102 using one or more data security strategies. For instance, the on-device contextual data can be encrypted, ensuring that data is converted into a secure format that can only be accessed by authorized entities. This can be achieved, for instance, through full-disk encryption or file-level encryption. Access control mechanisms can also be employed that limit access to the on-device contextual data to specific applications via authentication. For instance, access to the on-device contextual data could be authorized for just the prompt component 112 such that other applications and components on the user device cannot access the data.

In configurations using on-device contextual data, the prompt component 112 uses the received content intent descriptor and on-device contextual data in various ways to provide a prompt to the generative model 114. By way of example only and not limitation, in some aspects, the prompt component 112 simply provides the content intent descriptor and on-device contextual data as input to the generative model (i.e., the prompt is the content intent descriptor and on-device contextual data). In some aspects, the prompt component 112 provides a prompt (which could be pre-defined text) that instructs the generative model 114 to generate a digital content item using a combination of the content intent descriptor and on-device contextual data. In some aspects, the prompt component 112 generates the prompt by selecting specific types of on-device contextual data that are relevant to the content intent descriptor. For instance, if the content intent descriptor specifies generation of different content based on different age ranges, the prompt component 112 accesses age information for the end user from the on-device contextual data. In some aspects, the prompt component 112 uses on-device contextual data to select relevant information from the content intent descriptor for use in generating the prompt. For example, if the content intent descriptor includes information for multiple items (e.g., products), the prompt component 112 could generate a prompt using information for one of those items that aligns best with the end user's recent behavior data, such as previous engagement with similar items.

By way of example to illustrate, suppose the client device 102 receives a content intent descriptor that includes details about a new smartphone launch, including key features for different audiences (e.g., certain features for tech-savvy individuals and other features for non-tech-savvy individuals) and desired tone (innovative and exciting). In this example, the on-device contextual data on the user device 102 includes information regarding the end user's recent searches for smartphones indicating an interest in high-end smartphones and geolocation indicating the end user is in a tech hub. Given this content intent descriptor and on-device contextual data, the prompt component 112 generates a prompt to highlight the smartphone's cutting-edge features, tailored to appeal to tech enthusiasts, with a focus on innovation and excitement.

As another example, suppose the client device 102 receives a content intent descriptor that includes information about various news categories (sports, technology, politics) and the objective to increase user engagement. Also suppose the on-device contextual data includes the user's browsing history showing a preference for technology news and geolocation data indicating they are in an area with a recent tech event. In this example, the prompt component 112 generates a prompt that includes information from the content intent descriptor regarding the latest technology news with instructions to emphasize the recent tech event in the end user's area.

After the prompt component 112 generates a prompt from the received content intent descriptor (and, in some cases, on-device contextual data), the prompt is provided as input to the generative model 114 to generate a digital content item, which is presented by the application 108 on the user device 102. In some aspects, the generative model 114 comprises a language model that includes a set of statistical or probabilistic functions to perform Natural Language Processing (NLP) in order to understand, learn, and/or generate human natural language content. For example, a language model can be a tool that determines the probability of a given sequence of words occurring in a sentence or natural language sequence. Simply put, it can be a model that is trained to predict the next word in a sentence. A language model is called a large language model (LLM) when it is trained on enormous amount of data and/or has a large number of parameters. Some examples of LLMs are GOOGLE's BERT and OpenAI's GPT-4. These models have capabilities ranging from writing a simple essay to generating complex computer codes - all with limited to no supervision. Accordingly, an LLM can comprise a deep neural network that is very large (e.g., billions to hundreds of billions of parameters) and understands, processes, and produces human natural language by being trained on massive amounts of text. These models can predict future words in a sentence letting them generate sentences similar to how humans talk and write or otherwise in a form dictated, for instance, by a prompt.

The generative model 114 can comprise a neural network (i.e., an artificial neural network). As used herein, a neural network comprises multiple operational layers, including an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

In some aspects, the generative model 114 is optimized to fit on-device to perform content generations on user devices, such as the user device 102. The optimization of the generative model 114 can use any of a number of different techniques, such as pruning, quantization, knowledge distillation, and low-rank adaptation (LoRA). Implementing these techniques can make the generative model 114 more efficient and suitable for deployment on devices with limited resources, such as smartphones.

The generative model 114 in some configuration comprises a multimodal model having one or more neural networks (i.e., artificial neural networks) that provide an encoder-decoder architecture with a joint latent space for different modalities. As such, the generative model 114 can take input in one or more different modalities (e.g., text, images, audio, video, etc.) and generate an output in one or more different modalities (e.g., text, images, audio, video, etc.). By way of example only and not limitation, the generative model 114 can employ one or more of the following: a variational autoencoder (VAE), a generative adversarial network (GAN), a transformer, a cross-modal attention network, and a latent diffusion model.

When configured as a multimodal model, the generative model 114 can include separate encoders that generate latent representations of different input modalities. Each encoder comprises a neural network architecture that extracts features representing the input modality in a compressed, meaningful way. By way of example only and not limitation, text encoders for text data could employ recurrent neural networks (RNNs) or transformer-based architectures. Image encoders for image data could employ, for instance, convolutional neural networks (CNNs) or vision transformers. Audio and/or video encoders for audio/video data could employ, for instance, combinations of RNNs and CNNs (including 3-dimensional CNNs) or transformer-based architectures. In some configurations, the generative model 114 includes separate encoders for content intent descriptors and on-device contextual data.

The joint latent space of the multimodal model captures the underlying semantics of different modalities, allowing the model to understand and relate the information across the modalities. In order to provide combined latent representations of different modalities in the joint latent space, the model can also include a merging component that merges latent representations of different inputs (e.g., via concatenations, summation, average, and/or other fusion techniques). The combined latent representations in the joint latent space capture shared representations of different data types, allowing for interactions and transformations between modalities.

As multimodal model, the generative model 114 can also include one or more decoders to generate outputs. Each decoder comprises a neural network architecture specialized to produce a specific type of output given a latent representation in the joint latent space. By way of example only and not limitation, text decoders to generate text data could employ RNNs or transformer-based architectures. Image decoders for generating image data could employ, for instance, convolutional neural networks (CNNs) or vision transformers. Audio and/or video decoders for generating audio/video data could employ, for instance, combinations of RNNs and CNNs (including 3-dimensional CNNs) or transformer-based architectures.

In some configurations, the generative model 114 is a pre-trained model (e.g., GPT-4) that has not been fined-tuned. In other configurations, the generative model 114 is a model that is built and trained from scratch or a pre-trained model that has been fine-tuned. In such configurations, the generative model 114 can be trained or fine-tuned using training data. The training data comprise, for instance, training samples that each include an input comprising a sample content intent descriptor (and, in some cases, sample contextual data), as well as a ground truth digital content item. During training, weights associated with each neuron can be updated. Originally, the generative model 114 can comprise random weight values or pre-trained weight values that are adjusted during training. In one aspect, the generative model is trained using backpropagation. The backpropagation process comprises a forward pass, a loss function, a backward pass, and a weight update. The forward pass can include providing training data (e.g., a sample content intent descriptor and, in some cases, sample contextual data) as input to the generative model 114, which generates an output based on that input. A loss can be determined based on the output and the ground truth digital content item from the training sample, and the weights updated based on the loss. This process is repeated using the training data. The goal is to update the weights of each neuron (or other model component) to cause the generative model 114 to produce relevant digital content items when given prompts based on content intent descriptors (and contextual data, in some cases). Once trained, the weight associated with a given neuron can remain fixed. The other data passing between neurons can change in response to a given input. Retraining the network with additional training data can update one or more weights in one or more neurons.

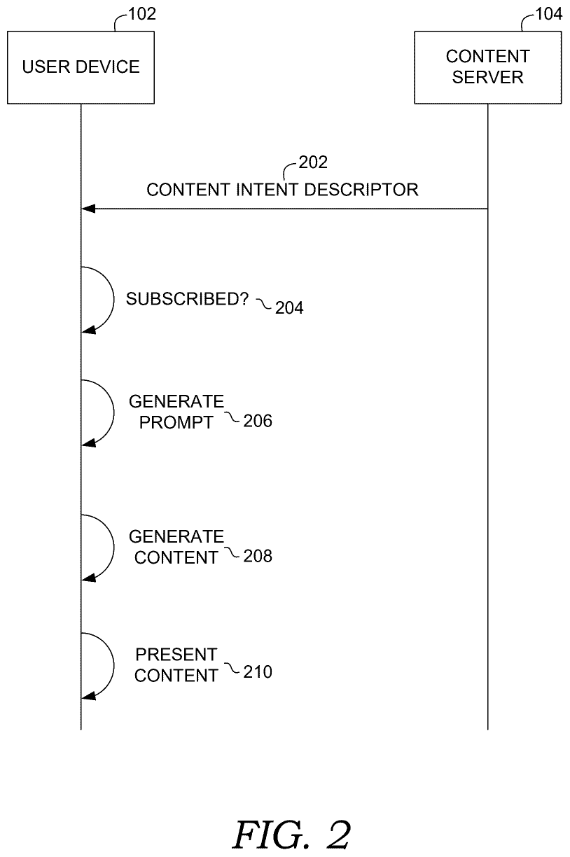

Turning next to FIG. 2, a sequence diagram is provided that shows a sequence of actions performed by the content server 104 and the user device 102 of FIG. 1 to generate digital content on the user device 102 using on-device subscription data and a content intent descriptor in accordance with some aspects of the technology described herein. At 202, the content server 104 provides a content intent descriptor over a network (e.g., the network 106) to the user device 102. At 204, the user device 102 access on-device subscription data (e.g., from the subscription data store 116) and uses the on-device subscription data to determine (e.g., by the subscription component 110) whether the user device 102 is subscribed to present digital content based on the content intent descriptor. This can include comparing the content intent descriptor to the on-device subscription data using one or more techniques. When the user device 102 determines it is subscribed, at 206, the user device 102 generates (e.g., by the prompt component 112) a prompt using the content intent descriptor. In some aspects, the user device also accesses on-device contextual data (e.g., from the contextual data store 118) and generates the prompt using the on-device contextual data in conjunction with the content intent descriptor. At 208, the user device 102 provides the prompt as input to an on-device generative model (e.g., the generative model 114), which outputs a digital content item based on the prompt. At 210, the user device 102 presents the digital content item (e.g., via the application 108).

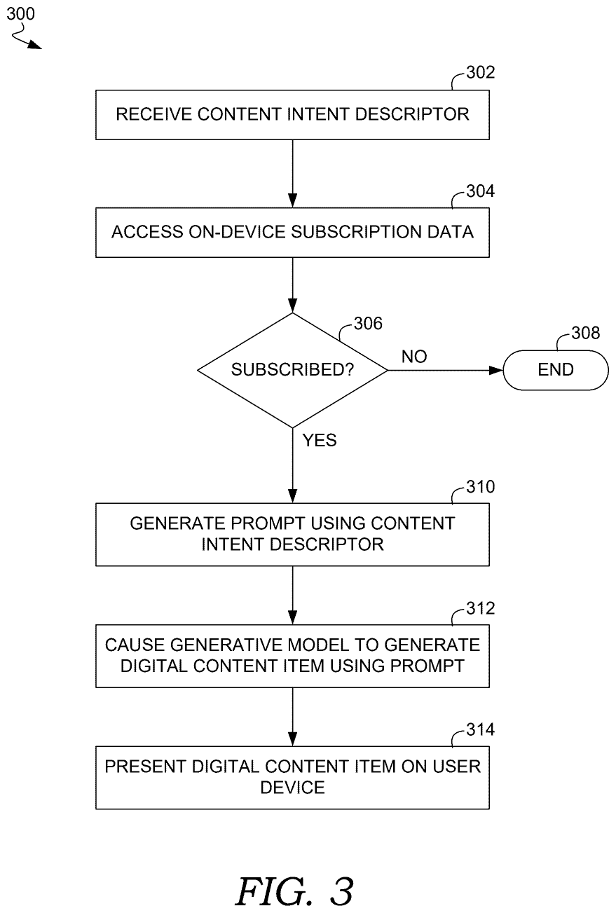

With reference now to FIG. 3, a flow diagram is provided that illustrates a method 300 performed by a user device to generate a digital content item on the user device using on-device subscription data and a content intent descriptor. The method 300 can be performed, for instance, by the user device 102 of FIG. 1. Each block of the method 300 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 302, a user device (e.g., the user device 102 of FIG. 1) receives a content intent descriptor communicated from a content server (e.g., the content server 104 of FIG. 1) over a network to the user device. The user device accesses on-device subscription data at block 304 and uses the on-device subscription data to determine at block 306 whether the user device is subscribed to present digital content based on the content intent descriptor. If not, the process ends at block 308.

Alternatively, if the user device determines it is subscribed to present digital content based on the on-device subscription data, the user device generates a prompt using the content intent descriptor, as shown at block 310. In some aspects, the user device also employs on-device contextual data to generate the prompt. In some aspects, this could simply comprise providing the content intent descriptor and on-device contextual data as input. In other aspects, this could include processing the content intent descriptor and/or on-device contextual data to generate the prompt, such as selecting certain data from the content intent descriptor based on the on-device contextual data and vice versa.

The user device provides the prompt as input to a generative model on the user device, causing the generative model to generate a digital content item using the prompt, as shown at block 312. Depending on the use case, the digital content item can comprise one or more modalities (e.g., text, images, audio, video, etc.). The user device then presents the generated digital content item, as shown at block 314.

FIGS. 1-3 illustrate configurations in which digital content items are generated on a user device using a generative neural network model (e.g., the generative model 114). In further aspects of the technology described herein, a script could be used in place of a generative neural network model to generate digital content items on a user device. In other words, in the context of FIG. 1, the script replaces the generative model 114 on the user device 102. The script could reside on the user device 102 or be provided by the content server 104 or another server. The script comprises code that, when executed by a user device, combines a content intent descriptor and on-device contextual data to generate a digital content item. For example, the content intent descriptor could be a template, and the script could populate portions of the template with on-device contextual data, such as the user's name or profile picture. Using such a script would typically not generate digital content items that are as rich as those provided by a generative neural network model, but the script could be executed on lower end devices as it has lower power and memory requirements relative to a generative neural network model.

### Server-Provided Content Presentation Using On-Device Subscription Data

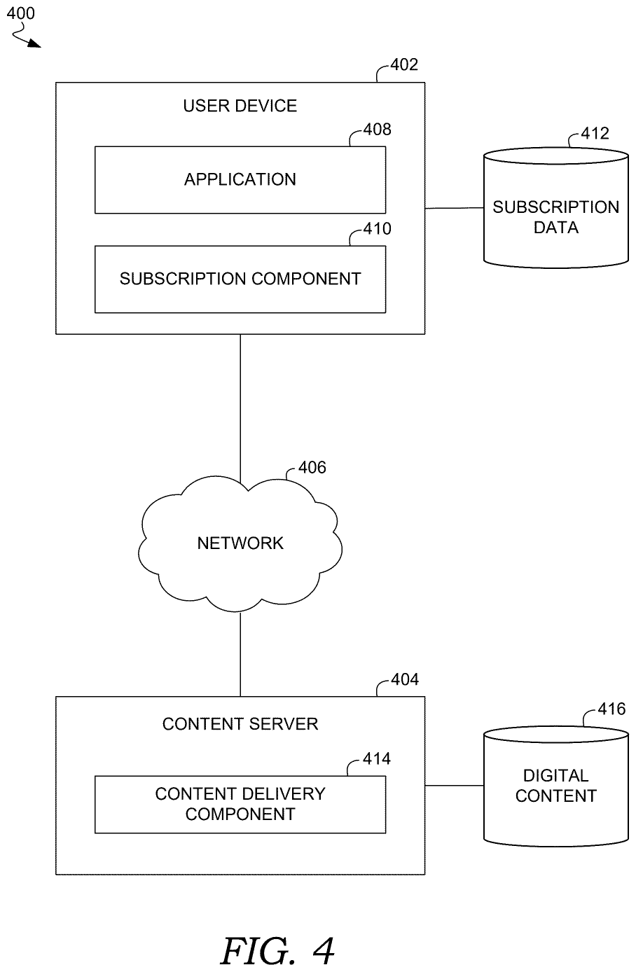

While FIGS. 1-3 illustrate a configuration in which a digital content item is generated on a user device based on on-device subscription data, FIGS. 4-6 illustrate a configuration in which a digital content item is provided by a content server to a user device and on-device subscription data is used to determine whether to present the digital content item on the user device. With initial reference to FIG. 4, a block diagram is providing illustrating an exemplary system 400 for presenting digital content items from a content server on a user device based on on-device subscription data in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The system 400 is an example of a suitable architecture for implementing certain aspects of the present disclosure. Among other components not shown, the system 400 includes a user device 402, which can be similar to the user device 102 of FIG. 1, and a content server 404, which can be similar to the content server 104 of FIG. 1. Each of the user device 402 and the content server 404 shown in FIG. 1 can comprise one or more computer devices, such as the computing device 800 of FIG. 8, discussed below. As shown in FIG. 4, the user device 402 and the content server 404 can communicate via a network 406, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 400 within the scope of the present technology. Each may comprise a single device or multiple devices cooperating in a distributed environment. For instance, the content server 404 could be provided by multiple server devices collectively providing the functionality of the content server 404 as described herein. Additionally, other components not shown may also be included within the network environment.

The user device 402 can be a client device on the client-side of operating environment 400, while the content server 404 can be on the server-side of operating environment 400. The content server 404 can comprise server-side software designed to work in conjunction with client-side software on the user device 402 so as to implement any combination of the features and functionalities discussed in the present disclosure. For instance, the user device 402 can include an application 408 for interacting with the content server 404 and presenting digital content items on the user device 402. The application 408 can be, for instance, a web browser or a dedicated application for providing functions, such as those described herein. This division of operating environment 400 is provided to illustrate one example of a suitable environment, and there is no requirement for each implementation that any combination of the user device 402 and the content server 404 remain as separate entities. While the operating environment 400 illustrates a configuration in a networked environment with a separate user device and content server, it should be understood that other configurations can be employed in which aspects of the various components are combined. For instance, in some aspects, aspects of the content server 404 can be implemented at least in part by the user device 402 and vice versa.

The user device 402 can comprise any type of computing device capable of use by a user. For example, in one aspect, the user device 402 can be the type of computing device 800 described in relation to FIG. 8 herein. By way of example and not limitation, the user device 402 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. An end user can be associated with the user device 402.

The content server 404 can be implemented using one or more server devices, one or more platforms with corresponding application programming interfaces, cloud infrastructure, and the like. While the content server 404 is shown separate from the user device 402 in the configuration of FIG. 4, it should be understood that in other configurations, at least some of the functions of the content server 404 can be provided on the user device 402 and vice versa.

As shown in FIG. 4, the user device 402 includes a subscription component 410; and the content server 404 includes a content delivery component 414. The components of the system 400 may be in addition to other components that provide further additional functions beyond the features described herein. In some aspects, the functions performed by components of the system 400 are associated with one or more applications, services, or routines. In particular, such applications, services, or routines may operate on one or more user devices, servers, may be distributed across one or more user devices and servers, or be implemented in the cloud. Moreover, in some aspects, these components of the system 400 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 400, it is contemplated that in some aspects, functionality of these components can be shared or distributed across other components.

Similar to the content server 104 of FIG. 1, the content server 404 is a computer system designed to store, manage, and deliver digital content over the network 406 to user devices, such as the user device 402. Among other things, the content server 404 maintains a repository of digital content items, shown in FIG. 4 as the digital content data store 416. Each digital content item can comprises one or more modalities (e.g., text, images, audio, video, etc.) The content delivery component 414 of the content server transmits digital content items over the network 406 to user devices, such as the user device 402.

Similar to the user device 102 of FIG. 1, the user device 402 stores on-device subscription data in a subscription data store 412 maintained on the user device 402. The user device 402 also includes a subscription component 410 that can be similar to the subscription component 110 of FIG. 1. Given a digital content item from the content server 404 and on-device subscription data from the subscription data store 412, the subscription component 410 determines whether to present the digital content item on the user device 402.

The subscription component 410 compares the digital content item (or metadata associated therewith) to the on-device subscription data to determine whether to present the digital content item. This can be done in a number of different ways. For instance, in some aspects, the subscription component 410 uses one or more of the following: keyword matching that determines if keywords from the digital content item (or from metadata associated therewith) match (or are similar to) keywords from the on-device subscription data; category matching that compares a category of the digital content item to preferred (and/or undesired) categories in the on-device subscription data; preference scoring that assigns a score to the digital content item as a function of how well the digital content item matches the end user's subscription preferences set forth by the on-device subscription data; and using machine learning approaches to determine whether to present the digital content item based on complex patterns in the on-device subscription data and/or the digital content item.

When the subscription component 410 determines that the user device 402 is not subscribed to the digital content item based on the on-device subscription data, the digital content item is not presented on the user device 402 and may be deleted from the user device 402. Alternatively, when the subscription component 410 determines that the user device 402 is subscribed to the digital content item based on the on-device subscription data, the user device 402 presents the digital content item.

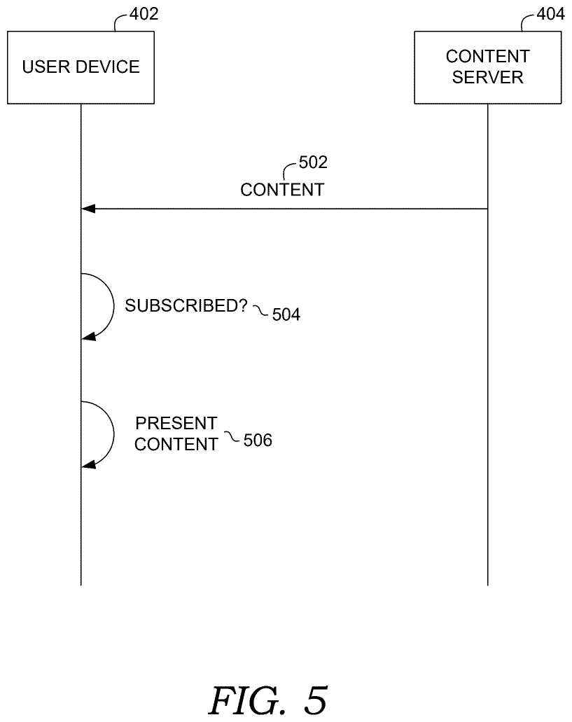

Turning next to FIG. 5, a sequence diagram is provided that shows a sequence of actions performed by the content server 404 and the user device 402 of FIG. 4 to determine whether to present a digital content item from the content server 404 on the user device 402 using on-device subscription data in accordance with some aspects of the technology described herein. At 502, the content server 404 provides a digital content item over a network (e.g., the network 406) to the user device 402. At 504, the user device 102 access on-device subscription data (e.g., from the subscription data store 412) and uses the on-device subscription data to determine (e.g., by the subscription component 410) whether the user device 102 is subscribed to present the digital content item. This can include comparing the digital content item (and/or metadata associated therewith) to the on-device subscription data using one or more techniques. When the user device 402 determines it is subscribed, at 506, the user device 402 presents the digital content item (e.g., via the application 408).

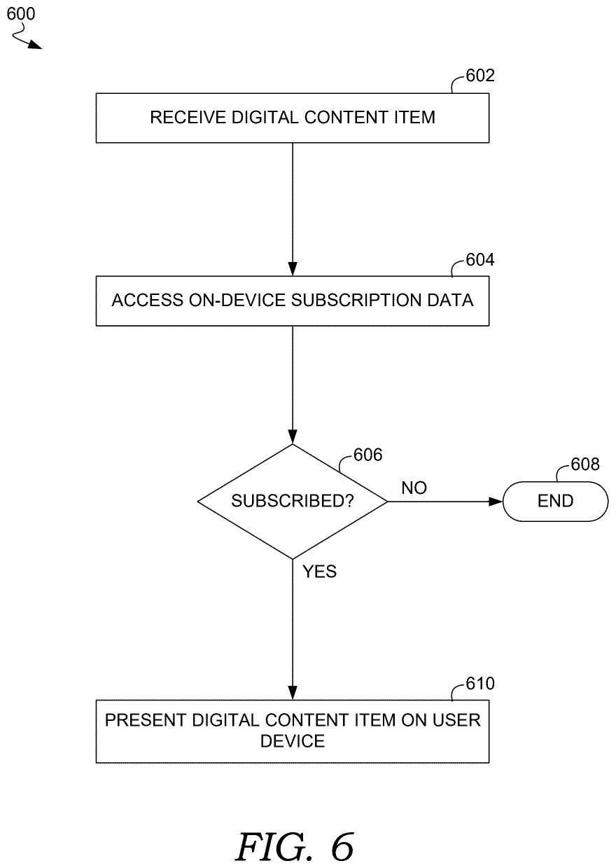

With reference now to FIG. 6, a flow diagram is provided that illustrates a method 600 performed by a user device to present server-provided digital content based on on-device subscription data. The method 600 can be performed, for instance, by the user device 402 of FIG. 4.

As shown at block 602, a user device (e.g., the user device 402 of FIG. 4) receives a digital content item communicated from a content server (e.g., the content server 404 of FIG. 4) over a network to the user device. The user device accesses on-device subscription data at block 604 and uses the on-device subscription data to determine at block 606 whether the user device is subscribed to present the digital content item. If not, the process ends at block 608. Alternatively, if the user device determines it is subscribed to present the digital content item based on the on-device subscription data, the user device presents the digital content item, as shown at block 610.

### Exemplary Operating Environment

Having described implementations of the present disclosure, an exemplary operating environment in which embodiments of the present technology may be implemented is described below in order to provide a general context for various aspects of the present disclosure. Referring initially to FIG. 7 in particular, an exemplary operating environment for implementing embodiments of the present technology is shown and designated generally as computing device 700. Computing device 700 is but one example of a suitable computing environment and is not intended to suggest any limitation as to the scope of use or functionality of the technology. Neither should the computing device 700 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output (I/O) ports 718, input/output components 720, and illustrative power supply 722. Bus 710 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 7 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc. The I/O components 720 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 700. The computing device 700 may be equipped with depth cameras, such as, stereoscopic camera systems, infrared camera systems, RGB camera systems, and combinations of these for gesture detection and recognition. Additionally, the computing device 700 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
receiving, at a user device, a content intent descriptor communicated over a network from a content server;
performing a comparison of the content intent descriptor to on-device subscription data;
based on the comparison, generating, on the user device, a prompt using the content intent descriptor;
causing a generative model to generate a digital content item using the prompt; and
presenting the digital content item on the user device.

2. The one or more computer storage media of claim 1, the comparison of the content intent descriptor to the on-device subscription data comprises comparing metadata associated with the content intent descriptor to the on-device subscription data.

3. The one or more computer storage media of claim 1, wherein the prompt is generated on the user device by selecting information from the content intent descriptor based on the on-device subscription data.

4. The one or more computer storage media of claim 3, wherein the content intent descriptor includes information for a plurality of items, and wherein the prompt is generated on the user device by selecting information for a first item from the plurality of items based on the on-device subscription data.

5. The one or more computer storage media of claim 1, wherein the prompt is generated on the user device also using on-device contextual data.

6. The one or more computer storage media of claim 5, wherein the prompt is generated on the user device by selecting information from the content intent descriptor based on the on-device contextual data.

7. The one or more computer storage media of claim 6, wherein the content intent descriptor includes information for a plurality of items, and wherein the prompt is generated on the user device by selecting information for a first item from the plurality of items based on the on-device contextual data.

8. The one or more computer storage media of claim 5, wherein the prompt is generated on the user device by selecting the on-device contextual data based on the content intent descriptor.

9. The one or more computer storage media of claim 5, wherein the prompt is generated on the user device by combining the content intent descriptor with the on-device contextual data.

10. The one or more computer storage media of claim 1, wherein causing the generative model to generate a digital content item using the prompt comprises:
providing the prompt as input to the generative model on the user device.

11. A computer-implemented method comprising:
receiving, at a user device, a digital content item communicated over a network from a content server;
performing a comparison of the digital content item to on-device subscription data; and
based on the comparison, presenting the digital content item on the user device.

12. The computer-implemented method of claim 11, wherein the comparison of the digital content item to the on-device subscription data comprises comparing metadata associated with the digital content item to the on-device subscription data.

13. A user device comprising:
a generative model;
a subscription data store storing on-device subscription data maintained on the user device;
a contextual data store storing on-device contextual data maintained on the user device;
one or more processors; and
one or more computer storage media storing computer-useable instructions that, when used by the one or more processors, cause the user device to perform operations comprising:
receiving, at the user device, a content intent descriptor communicated over a network from a content server,
performing a comparison of the content intent descriptor to the on-device subscription data from the subscription data store,
based on the comparison, generating, on the user device, a prompt using the content intent descriptor and the on-device contextual data from the contextual data store,
causing the generative model to generate a digital content item using the prompt, and
presenting the digital content item on the user device.

14. The user device of claim 13, wherein the comparison of the content intent descriptor to the on-device subscription data comprises comparing metadata associated with the content intent descriptor to the on-device subscription data.

15. The user device of claim 13, wherein the prompt is generated on the user device by selecting information from the content intent descriptor based on the on-device subscription data.

16. The user device of claim 15, wherein the content intent descriptor includes information for a plurality of items, and wherein the prompt is generated on the user device by selecting information for a first item from the plurality of items based on the on-device subscription data.

17. The user device of claim 13, wherein the prompt is generated on the user device by selecting information from the content intent descriptor based on the on-device contextual data.

18. The user device of claim 17, wherein the content intent descriptor includes information for a plurality of items, and wherein the prompt is generated on the user device by selecting information for a first item from the plurality of items based on the on-device contextual data.

19. The user device of claim 13, wherein the prompt is generated on the user device by selecting the on-device contextual data from the contextual data store based on the content intent descriptor.

20. The user device of claim 13, wherein the prompt is generated on the user device by combining the content intent descriptor with the on-device contextual data.
